(19) United States
(12) Patent Application Publication
(10) Pub. No.: US 2006/0163818 A1
(43) Pub. Date: Jul. 27, 2006

(54) Shaft seal with memory metal retainer spring

(76) Inventor: Bryan S. Breen, Commerce Township, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/041,680

(22) Filed: Jan. 24, 2005

(51) Int. Cl. F16J 15/32

(52) U.S. Cl. 277/553

(57) ABSTRACT

The present invention discloses a shaft seal assembly. A seal retainer member is created from a shape memory alloy and used in combination with a resilient body to seal a shaft. Any deformities in the retaining member upon installation can be corrected through application of an electric current, or through heat, such as that created by an internal combustion engine. This heat forces the retaining member to retain a consistent shape, and a generally constant spring force, despite any eccentricities in the shaft or retaining member.

### TECHNICAL FIELD

The present invention relates generally to sealing methods and, more particularly, to seals containing resilient bodies disposed about shafts and held in place by retaining springs, bands or rings.

### BACKGROUND OF THE INVENTION

Shape memory alloys, such as Nitinol, are known in the art. These materials can be given a “memory” shape upon formation, through methods known to those familiar with the art. Once given a memory shape, if this material is subsequently deformed, the application of sufficient heat or an electric current will cause the material to return to its original “memory” shape.

It is also known that shaft seal assemblies are used to seal against fluid leakage between the environment on one end of the seal and the other. One typical shaft seal takes the form of a cylinder partially closed at one end by an upper lip of the resilient body comprising the seal. The cylindrical region seats about a shaft guide to maintain the shaft seal stationary. An upper region of the shaft is surrounded by the seal when the shaft is fully inserted into the seal assembly.

Conventional seal assemblies often comprise two main parts: 1) a resilient body positioned at one end to control fluid leakage between the shaft and guide, and 2) a structural cylindrical part called a retainer which is mounted either on top of or around the guide. The seal assembly is frictionally secured to the guide. Eccentricities in shafts and guides can cause improper sealing of the shaft when using this manner of seal.

Another seal assembly is an umbrella seal which comprises an upper and a lower cylindrical portion, wherein the upper portion is frictionally secured to the shaft. The lower portion has an inner diameter greater than that of the shaft guide, permitting the lower portion to be seated around the upper portion of said shaft guide. Unlike seals which remain stationary and affixed to the shaft guide as the shaft reciprocates within it, the umbrella seal reciprocates with the shaft. This requires tight tolerances between the seal and the shaft, typically necessitating different sized seals for every size of shaft. Any deformities in the shaft or the seal can hamper the seal and allow fluid to pass through.

It is known in the art that some seals, including seals of both of the above-mentioned styles, have a retainer spring or band to help maintain a better seal between the resilient body and the shaft.

However, conventional retainer springs and bands can become damaged during shipping, installation, handling or prolonged use, and become virtually useless in the application. This leads to increased scrap and warranty costs, and decreased efficiency due to oil loss through the seal.

Further, it is known in the art that some seals contain sensors and associated wires. These “smart seals” are capable of passing information regarding the environment in which the seal is located to a remote recording or monitoring device.

### SUMMARY OF THE INVENTION

The present invention minimizes the potential of a deformed seal spring, band or ring being used, and addresses improper sealing caused by eccentricities in shafts and the like. In one aspect, the invention comprises a resilient member and a retaining member. The resilient member is preferably made of a polymeric material, and more preferably of a synthetic polymeric material. The retaining member is made of a shape-memory alloy, such as one formed by a combination of Nickel and Titanium, preferably in the form of a garter spring, a band spring or a ring spring. The retaining member provides a constant inwardly directed force on the resilient member to maintain a seal around a reciprocating or rotating shaft. However, should the retaining member become deformed, either during handling, shipping, installation or use, the application of heat or an electric current causes the shape-memory action of the disclosed retaining member to return to its original shape and compression force, thereby maintaining the sealing properties of the resilient body. In an internal combustion engine, the required heat may be provided by the chemical reactions taking place in the combustion chamber, thereby causing the retaining member to consistently apply the desired compression force to the seal during normal engine operation. Alternatively, if the intended seal is a “smart seal”, the sensor wires may be used to supply an electric current to the retaining member, thereby ensuring a consistent, inwardly-directed compression force. Other methods of re-shaping the memory-metal are also contemplated.

### BRIEF DESCRIPTION OF THE DRAWINGS

The present invention will now be described, by way of example, with reference to the accompanying drawings, in which:

FIGS. 1A and 1B illustrate a seal assembly according to the current invention.

FIGS. 2A-2C illustrates perspective views of various embodiments of retaining members for use in the seal assembly of FIGS. 1A and 1B.

FIG. 2D illustrates a first alternative embodiment of the seal assembly as according to the invention wherein the retaining member is molded within the body of the seal assembly.

FIG. 3 illustrates a cross-sectional view of an umbrella seal assembly in the present invention.

FIG. 4 illustrates a perspective view of the umbrella seal assembly of FIG. 3.

FIG. 5 illustrates a second alternative embodiment of a seal assembly according to the present invention wherein the retaining member is disposed within a trough formed in the body of the seal assembly.

FIG. 6 illustrates a cross-sectional view of the seal assembly of FIG. 5.

FIG. 7 illustrates a cross-sectional view of a third alternative embodiment of the seal assembly as according to the invention wherein the retaining member is disposed between spaced apart circumferential protrusions.

FIG. 8 illustrates a perspective view of the embodiment of the seal assembly of FIG. 7.

FIG. 9 illustrates a perspective view of a forth alternative embodiment of the seal assembly as according to the invention wherein the retaining member is disposed between spaced apart rows of protruding bumps.

### DESCRIPTION OF THE PREFERRED EMBODIMENT

Embodiments of a seal assembly as according to the invention are adapted to be arranged on a valve shaft such that the seal assembly reciprocates with the valve or remains stationary in relation to valve movement for removing fluid adhered to the valve shaft. A retaining member included in the seal assembly is adapted to be adjustable for facilitating either arrangement.

It is known that conventional retaining members can become damaged during shipping, installation, handling or prolonged use, and become virtually useless for the intended application. The retaining member used in embodiments of the present invention addresses these concerns and is capable of providing and maintaining a functional seal about the valve shaft despite having become deformed prior to or during actual use.

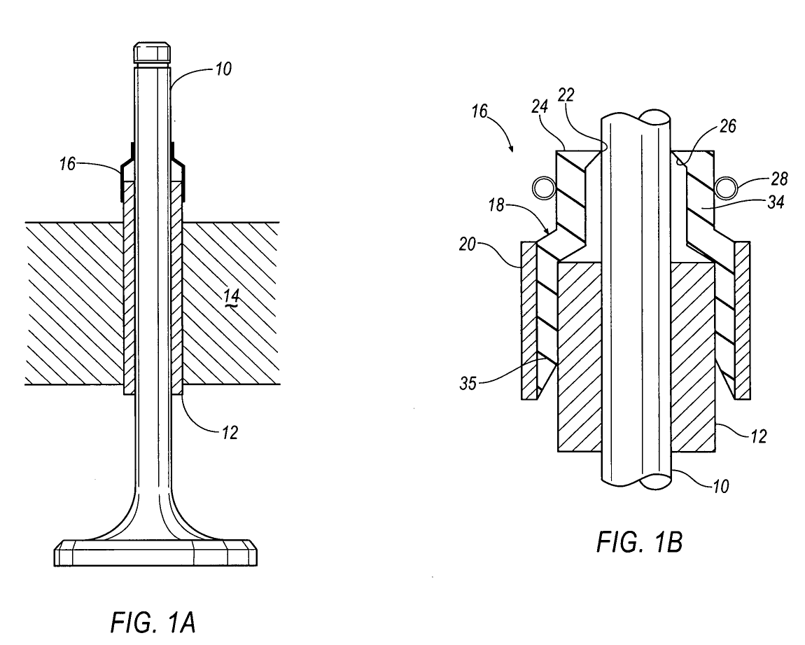

FIG. 1A illustrates a cross-sectional view of a seal assembly used as a valve seal according to one embodiment of the present invention. Seal 16 is fixed on top of shaft guide 12 and forms a seal around reciprocating shaft 10, which is disposed in shaft guide 12. Shaft guide 12 is fixed in a holder 14.

Referring now to FIG. 1B, shaft seal 16 includes a body 18 enclosed within and fixedly attached to a structural cylindrical retainer 20. Body 18 may be formed of a number of materials. Preferred are resilient polymeric materials such as rubber or synthetic polymers with elastomeric properties. Alternatively, the body 18 may be formed of a non-resilient, but flexible, material such as rubber or synthetic polymers that lack elastomeric properties. In such case, a retaining member 28, described hereinafter, is primarily relied upon for holding the body 18 tightly against the shaft to form the seal.

Still referring to FIG. 1B, body 18 includes an upper cylindrical portion 34 and a lower cylindrical portion 35. The diameter of the upper cylindrical portion 34 of body 18 is slightly less than the outer diameter of the shaft guide 12, and slightly larger than the outer diameter of reciprocating shaft 10. Body 18 further includes an uppermost portion with an inner face 26, an outer face 24 and an opening or bore 22. The opening 22 has a diameter slightly less than that of the reciprocating shaft 10 such that it forms a seal when pressed over the shaft 10. Outer face 24 in this embodiment has portions which are perpendicular to and portions which are parallel to reciprocating shaft 10. In one embodiment, inner face 26 is tilted at an angle extending downward and outward from the opening 22 at the outer face. The resultant shape allows the seal to catch fluids adhering to the reciprocating shaft as it travels up and down within the shaft guide 12.

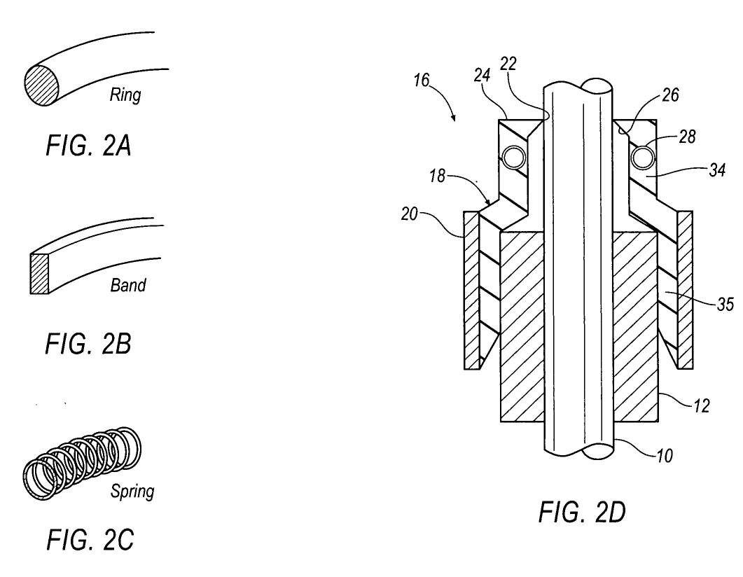

Shaft seal 16 further includes in this embodiment a retaining member 28, shown here as garter spring (See FIG. 2C), disposed around the upper cylindrical portion 34 and below the opening, made from a shape memory alloy. As illustrated in FIGS. 2A and 2B, other types of retaining members 28 may also be used for such purpose without exceeding the scope of the invention, including a ring spring or a band spring, respectively. As best illustrated in an alternative of FIG. 2D, the retaining member 28 may be embedded within the body 18 proximate the upper cylindrical portion 34 thereof without exceeding the scope of the invention. This may be accomplished by a material molding process known to those skilled in the art.

As will be understood by those skilled in the art, shape memory alloy metals can be heat treated to remember a particular shape. If this shape is subsequently deformed, the original shape can be regained by applying heat (or an electric current) to the metal. In the present invention, this thermo mechanical behavior is used to form a relatively tight-sealing retaining member 28 as the memory shape. If deformed, this shape is restored by the application of heat or current. The temperature at which this shape restoration event occurs can be adjusted by manipulating the proportions of the metals in the alloy. The properties of shape memory alloy metals are well known in the art. Preferred for use herein are alloys of nickel and titanium (Nitinol), such as about 55 percent by weight nickel and about 45 percent by weight titanium, or closer to a 50/50 ratio of these metals.

Properties of shape memory alloys are described in the paper entitled, “Time Response of Shape Memory Alloy Actuators,” Journal of Intelligent Material Systems and Structures, V.ii, Feb. 2000 pp. 125-134, the entire disclosure of which is incorporated herein by reference.

Retaining member 28 ensures that the body 18 provides a consistent seal by applying a generally constant inwardly directed force around the exterior of the upper cylindrical portion 34 near the opening 22. The shaft seal 16 may be situated sufficiently close to a heat source (not shown), such as the combustion chamber of an internal combustion engine so that heat is transferred from the heat source sufficient to cause the retaining member 28 to return to, or maintain, its “memory” shape. As a result, retaining member 28 ensures a generally constant predetermined spring force, inwardly directed along the radius of the opening 22 regardless of any previous plastic deformation of retaining member 28.

Alternatively, the above described seal may be attached to an electrical current source (not shown) such that application of the electric current causes the garter spring, ring spring or band spring to return to the “memory” shape. If the above seal is a “smart seal,” sensors may sense a loosening of the seal and actuate the application of electrical current to the retaining member 28. The electric current may come from wires associated with the imbedded sensors, or from any other source appropriate to the required application.

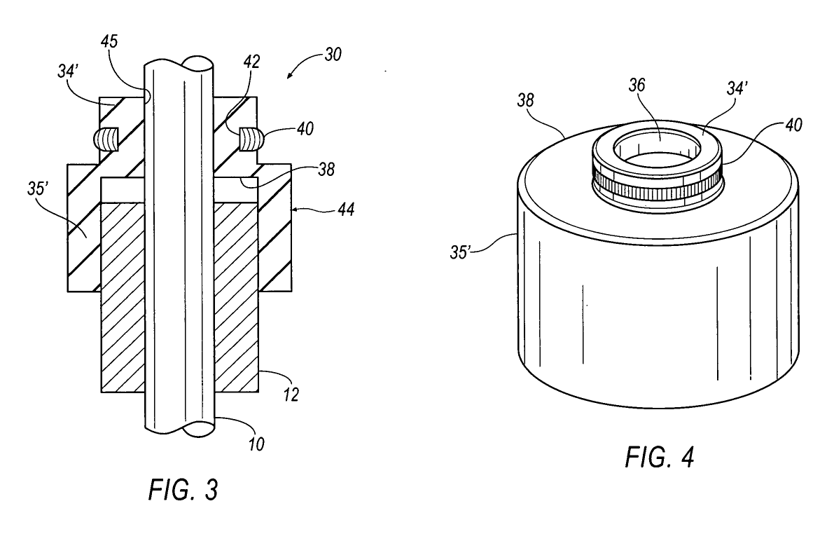

FIGS. 3 and 4 illustrate an umbrella seal 30 according to another embodiment of the present invention generally comprising a resilient body 44 and a retaining member 40. Referring to the cross-sectional view of FIG. 3, the resilient body 44 comprises an upper cylindrical portion 34′ and a lower cylindrical portion 35′ and is preferably made of a polymeric material. The lower cylindrical portion 35′ has an inner diameter that is greater than the outer diameter of a shaft guide 12 such that the lower cylindrical portion 35′ of the resilient body 44 is seated around the top of the shaft guide 12. The upper cylindrical portion 34′ has an inner diameter slightly less than that of the shaft 10 such that an inner face 45 of the upper cylindrical portion 34′ forms a seal against the shaft 10.

Still referring to FIG. 3, the upper cylindrical portion 34′ further includes a trough 42 around its periphery in which is disposed retaining member 40. Retaining member 40 is made of a shape memory alloy such as Nitinol as described above. Retaining member 40 provides a constant inwardly directed radial force against the outer surface of the upper cylindrical portion 34′. Seal 30 may be situated sufficiently close to a heat source (not shown) so that enough heat is transferred from the heat source to cause the retaining member 40 to return to, or maintain, its “memory” shape, thereby ensuring a generally consistent compressive force around the resilient body 44 through the life of the seal 30.

Alternatively, an electrical source may be employed such that the application of an electrical potential to the retaining member 40 causes the member 40 to revert to its memory condition, thereby forcing a constant sealing pressure around the periphery of the resilient body 44. This electric current could be provided by wires associated with a “smart seal”.

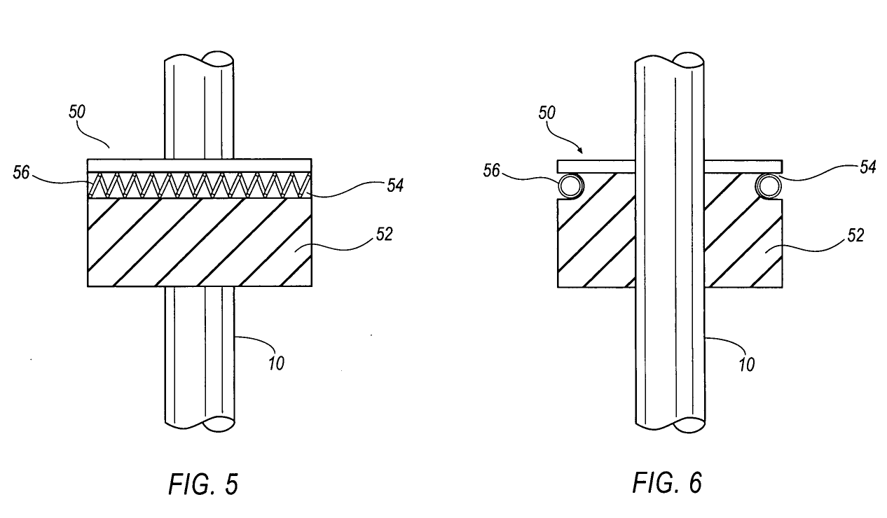

FIGS. 5 and 6 illustrate a further embodiment of the present invention. Seal assembly 50 includes a body 52 having an inner diameter slightly less than the outer diameter of shaft 10. Seal assembly 50 has a retaining member 56, which encircles resilient body 52, applying a generally constant inward force. This inward force will allow the resilient body 52 to maintain a generally consistent seal around the shaft regardless of any inconsistencies in the shaft or the seal. Resilient body 52 is preferably made of a polymeric material, and more preferably of a synthetic polymeric material. Retaining member 56 is made of a shape memory alloy metal and can be a garter spring, a ring spring, a band spring, combinations thereof, or any other embodiment appropriate for the application, as known to those familiar with the art.

As best illustrated in FIG. 6, seal assembly 50 includes a groove or channel 54 around the periphery of resilient body 52 in which retaining member 56 is seated. It is to be understood that the bore of resilient body 52 has a diameter which, in combination with the resiliency of body 52, grips the outer surface of shaft 10. This gripping force, as aided by retaining member 56, is such that seal assembly 50 moves with reciprocation of shaft 10 or, alternatively, allows shaft 10 to move while seal assembly 50 remains stationary to effectively wipe lubricant from the shaft.

Thus, the biasing force of the shape memory alloy metal retaining member 56 can either retain the resilient body of the seal tightly on the shaft such that the seal reciprocates with the shaft or less tightly such that the shaft may move relative to the resilient body.

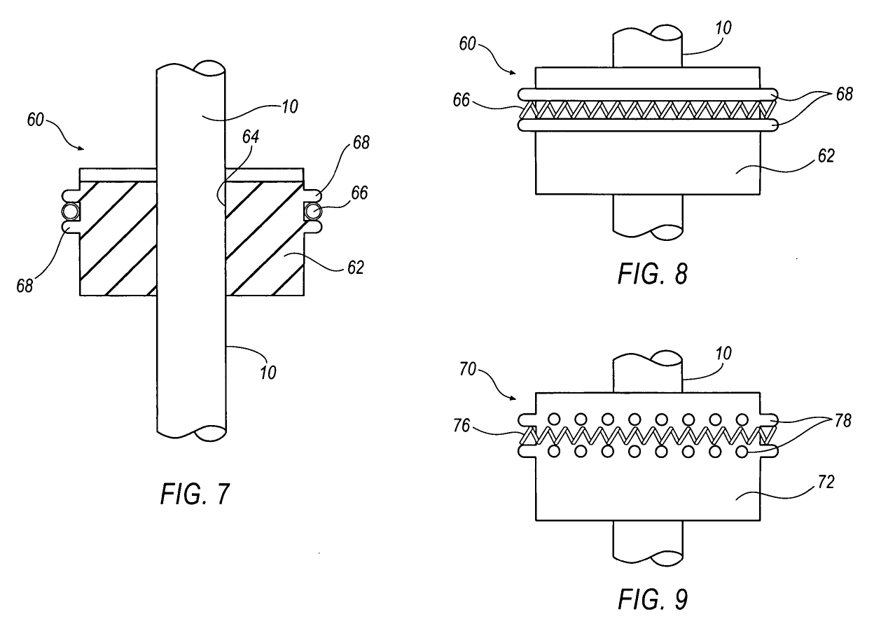

FIGS. 7 and 8 illustrate still another embodiment of the present invention. Seal assembly 60 includes a body 62 having an inner diameter 64 slightly less than the outer diameter of shaft 10. Seal assembly 60 has a retaining member 66, which encircles body 62, applying a generally constant inward force. This inward force will allow the body 62 to maintain a consistent seal around the shaft regardless of any inconsistencies in the shaft or the seal. Body 62 is preferably made of a polymeric material, and more preferably of a synthetic polymeric material having elastomeric properties. However, it is appreciated that the body 62 may be formed from a material that substantially lacks elastomeric properties without exceeding the scope of the invention. Retaining member 66 is made of a shape memory alloy metal and can be a garter spring, a ring spring, a band spring, combinations thereof, or any other embodiment appropriate for the application, as known to those familiar with the art.

As best illustrated in FIG. 8, seal assembly 60 includes protrusions 68 around the circumference of body 62 in which retaining member 66 is seated. The protrusions are spaced apart wherein the spacing between the protrusions 68 corresponds to a distance slightly greater the width or outer diameter of the retaining member 66. The bore of body 62 has a diameter that substantially grips the outer surface of shaft 10. This gripping force, as aided by retaining member 66, is such that seal assembly 60 moves with reciprocation of shaft 10 or, alternatively, allows shaft 10 to move while seal assembly 60 remains stationary to effectively wipe lubricant from the shaft.

FIG. 9 illustrates ail alternative embodiment of the seal assembly of FIGS. 7 and 8. Seal assembly 70 includes of a body 72 disposed about the outer diameter of shaft 10. Seal assembly 70 has a retaining member 76 which encircles body 72, applying a generally constant inward force. This inward force will allow the body 72 to maintain a consistent seal around the shaft regardless of any inconsistencies in the shaft or the seal.

Seal assembly 70 includes a plurality of protrusion bumps 78 aligned circumferentially around of body 72. As illustrated, the body 72 is disposed with a plurality of spaced apart rows protrusion bumps 78 wherein the spacing between the rows corresponds to a distance slightly greater than the width or outer diameter of the retaining member 76 which is adapted to be seated between the adjacent rows of protruding bumps 78. It is understood that the body 72 is required to be disposed with at least two rows of spaced apart protrusion bumps 78 as according to this embodiment of the invention.

It is also to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled. The disclosures of all articles and references, including patent applications and publications cited herein are incorporated herein by reference for all purposes.

What is claimed is:

1. A seal assembly comprising:
a body, which defines an opening, said opening having a diameter dimensioned to receive a shaft;
a retaining member encircling at least a portion of said body, said retaining member being formed of a shape memory alloy metal and having a memory shape that compresses said body radially inwardly;
wherein an unwanted deformation of said retaining member can be at least minimized by applying heat or an electrical current to said retaining member to restore said retaining member toward its memory shape.

2. The invention recited in claim 1, wherein said body is formed of a resilient or non-resilient material.

3. The invention recited in claim 1, wherein said retaining member is selected from the group consisting of a band spring, a ring spring and a garter spring or combinations thereof.

4. The invention recited in claim 1, wherein said shape memory alloy metal is an alloy including both nickel and titanium

5. The invention recited in claim 4, wherein nickel forms about 55% by weight of said retaining member and titanium forms about 45% by weight of said retaining member.

6. The invention recited in claim 1, wherein said heat is supplied from an internal combustion engine.

7. The invention recited in claim 1, further including a sensor associated with said body for determining when said electrical current is to be applied.

8. The invention recited in claim 1, wherein said body is formed of a polymeric material.

9. The seal assembly of claim 1 further comprising at least two spaced apart and circumferential protrusions encircling at least a portion of said body, said retaining member adapted to be disposed in between said spaced apart protrusions.

10. The seal assembly of claim 1 further comprising a plurality of spaced apart rows of protrusion bumps encircling at least a portion of said body, said retaining member adapted to be disposed in between said spaced apart protrusion bumps.

11. A method of sealing a shaft comprising the steps of:
providing a resilient body defining a bore;
providing a retaining member made of a shape memory alloy metal and having a memory shape;
wherein said resilient body is closely disposed around the periphery of the shaft;
wherein said retaining member extends around the external perimeter of said resilient body; and
applying heat or an electric current to said retaining member to provide an inwardly directed force around the periphery of said resilient body.

12. The method recited in claim 11, wherein said retaining member is selected from the group consisting of a band spring, a ring spring and a garter spring and combinations thereof.

13. The method recited in claim 11, wherein said shape memory alloy metal is an alloy including both nickel and titanium.

14. The method recited in claim 13, wherein nickel forms about 55% by weight of said retaining member and titanium forms about 45% of said retaining member.

15. The method recited in claim 11, further including a sensor associated with said resilient body for determining when said electrical current is to be applied.

16. A seal assembly for use in sealing a shaft, said seal comprising:
a body that defines an opening;
a retaining member embedded into an upper cylindrical portion of said body, said retaining member being formed of a shape memory alloy metal and having a memory shape, which compresses said body radially inwardly;
wherein a plastic deformation of said retaining member can be eliminated by applying heat or an electrical current to said retaining member to restore said retaining member to its memory shape.

17. The invention recited in claim 16, wherein said retaining member is selected from the group consisting of a band spring, a ring spring and a garter spring or combinations thereof.

18. The invention recited in claim 16, wherein said shape memory alloy metal is an alloy including both nickel and titanium

19. The invention recited in claim 18, wherein nickel forms about 55% by weight of said retaining member and titanium forms about 45% by weight of said retaining member.

20. The invention recited in claim 1, wherein said heat is supplied from an internal combustion engine.
